(19) United States
(12) Patent Application Publication
(10) Pub. No.: US 2006/0106845 A1
(43) Pub. Date: May 18, 2006

(54) System and method for computer-based local generic commerce and management of stored value

(75) Inventors: Alexander Frank, Bellevue, WA (US); Curt Andrew Steeb, Redmond, WA (US); David B. Edelstein, Seattle, WA (US); James Duffus, Seattle, WA (US); Mark C. Light, Redmond, WA (US); Paul Christopher Sutton, Seatac, WA (US); Thomas G. Phillips, Bellevue, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/007,089

(22) Filed: Dec. 8, 2004

Related U.S. Application Data
(63) Continuation-in-part of application No. 10/988,907, filed on Nov. 15, 2004.

(51) Int. Cl. G06F 17/00; G06F 7/00

(52) U.S. Cl. 707/101

(57) ABSTRACT

A computer is configured for pay-per-use or prepaid operation using internally stored value that may be directed to various aspects of the computer's operation, for example, printing or use of a particular application program. The value used may be logged and that information may be transferred to a host where individual service providers may be compensated for purchases made on the computer according to usage. The user may be presented with payment options such as single use or subscription for a given local purchase decision. A method of operation is also disclosed.

This application is a continuation-in-part of U.S. patent application, “Method and Apparatus for Provisioning Software,” filed Nov. 15, 2004 under attorney docket number 30835/40399.

### BACKGROUND

Personal computers and peripherals, which make up, a personal computing system, are usually sold or leased on a perpetual use basis. That is, when in the user's possession, he or she has full access to and use of the entire system, both hardware and software for the life of the system. This is limiting to some users who rarely use a particular feature of a pc system, but have to pay as if they used the feature on a routine basis.

In other instances, a user may not have the upfront funds to purchase outright a fully configured personal computing system including not only the base hardware and operating system, but peripherals and application programs as well.

In both instances it is desirable to offer the user an alternative to the high up-front costs of a personal computing system.

### SUMMARY

A computer is constructed for use in a system that may be designed to allow users to make purchase decisions related to computer use as they use the computer. A local value account may be given value. When the user wishes to use a service or resource, for example, playing a game, connecting to the Internet, or printing copies of a document, the user may be presented with the option of paying from the local value account for the use of that service or resource. The choices may include paying for a single use, subscribing to the service over a period of time, or deferring use. At some interval, the computer may connect to a server that financially reconciles use of the various services offered with their respective service providers.

### BRIEF DESCRIPTION OF THE DRAWINGS

FIG. 1 is a block diagram of a network interconnecting a plurality of computing resources;

FIG. 2 is a block diagram of a system in accordance with an embodiment of the current disclosure; and

FIG. 3 is a block diagram of a computer that may be connected to the network of FIG. 1;

FIG. 4 is a block diagram of the local provisioning module of the computer of FIG. 3.

FIG. 5 is a sequence diagram illustrating a method of operating the system of FIG. 2.

### DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the various embodiments.

### A Network

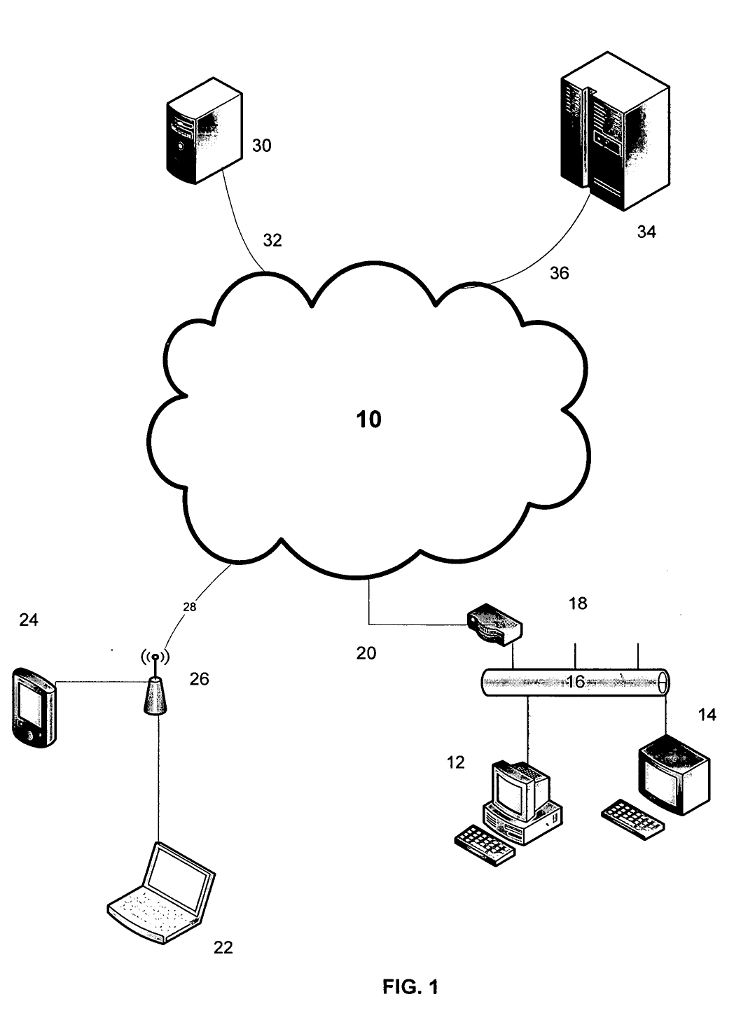

FIG. 1 illustrates a network 10 that may be used to implement a dynamic software provisioning system. The network 10 may be the Internet, a virtual private network (VPN), or any other network that allows one or more computers, communication devices, databases, etc., to be communicatively connected to each other. The network 10 may be connected to a personal computer 12 and a computer terminal 14 via an Ethernet connection 16, a router 18, and a landline 20. On the other hand, the network 10 may be wirelessly connected to a laptop computer 22 and a personal digital assistant 24 via a wireless communication station 26 and a wireless link 28. Similarly, a server 30 may be connected to the network 10 using a communication link 32 and a mainframe 34 may be connected to the network 10 using another communication link 36.

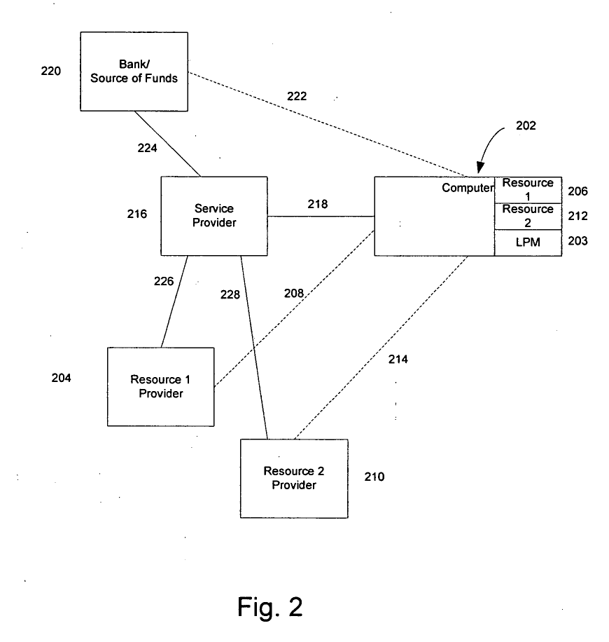

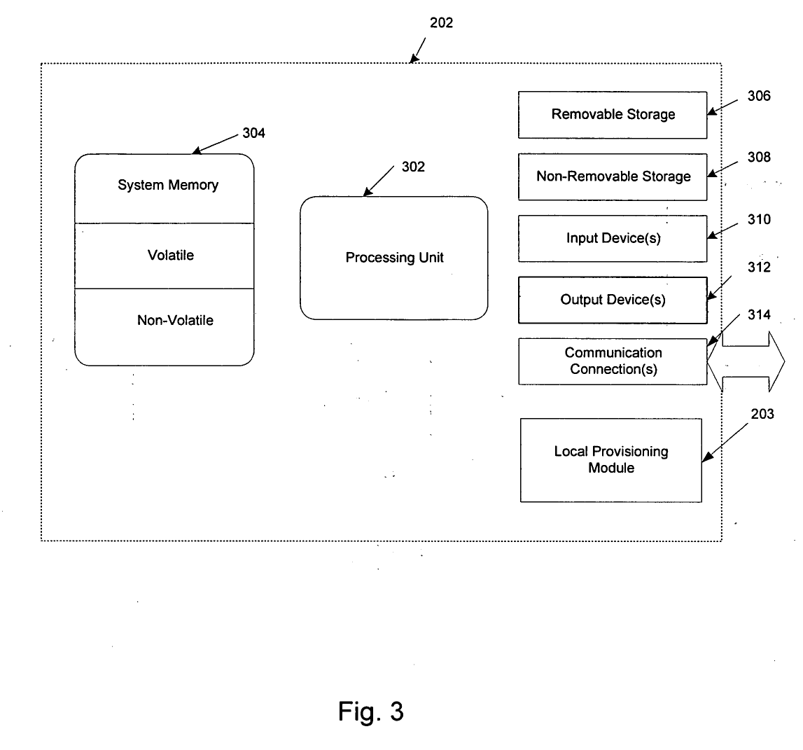

Referring to FIG. 2, a system 200 implementing an exemplary embodiment of a pay-per-use or pay-as-you go computing environment is discussed and described. An exemplary computer 202 may have a local provisioning module (LPM) 203 and resources 204 and 206. The LPM 203 may manage and securely store value that can be applied toward the use of one or more computer resources 204, 206. The resources 204, 206 may be any of the components shown in FIG. 3 and discussed in detail below, including but not limited to, storage devices 306 308, input/output devices 310 312, communications 314, application programs or application data stored in memory 304, or media content (not depicted). The resources 204, 206, in the embodiment shown, may be associated with first and second resource providers 208 and 210, respectively. The resources 204, 206 may be provisioned in the computer 202 at any point prior to their use, for example, during manufacturing, set-up or previous operation. Provisioning the resources 204, 206 may be accomplished physically or logically as represented by links 208, 214 respectively. The resources 204, 206 are provisioned in a manner that allows metering or gating of their operation. Metering their operation may include monitoring an aspect of their operation, such as number of launches, the time (duration) of use, use over a period of time, such as a calendar month, or use of a particular aspect, such as saving data generated by an application program, or output, such as printing. Installation may be performed by any number of parties with physical or logical access to the computer 202 including the resource providers 204, 210, a user (not depicted), the manufacturer (not depicted), or a service provider 216.

The service provider 216 may be coupled to the computer 202 via a link 218, preferably in real time, but off-line mechanisms work equally well. Examples of real-time connections may include dial-up access or the Internet. Off-line mechanisms for the link 218 may include known methods, for example, smart cards, other removable media, or even hardcopy information suitably coded to ensure accuracy and authenticity. The service provider 216 may use the link 218 to send provisioning packets to add value to the computer 202, as discussed in more detail below. The link 218 may also serve to pass reconciliation data from the computer 202 to the service provider 216. The service provider 216 may be a telephone company or an Internet service provider whose primary motive may be to increase traffic. Alternately, the service provider 216 may be an aggregator or clearinghouse with a more limited focus on the distribution and support of computers, such as computer 202. While a single service provider 216 is shown, more than one service provider 216 may be supported by the computer 202, although it may be desirable to have each service provider 216 associated with non-overlapping functionality, such as peripherals vs. application programs.

An additional participant may optionally be a bank, a telephone company, a utility company, a credit card company, or other funding source 220. In some cases, the funding source 220 may be incorporated by the service provider 216. Links 222 and 224, be they real-time or off-line, may couple the funding source 220 to the computer 202 and to the service provider 216, respectively. The actual funding process may take advantage of any of numerous known account types, for example, a standard bank savings or checking account, a prepaid account, a stored value account, a credit card account, a telephone postpaid account, etc. Depending on the funding account and the contractual relationships between the service provider 216, the funding account, and third party merchants, the value on the computer 202 may be used:to support standard electronic-commerce transactions. Since the overhead for the funding, value transfer and clearing is already accounted for, such an e-commerce payment mechanism may be more successful than previous attempts at cash replacement systems.

With reference to FIG. 3, the exemplary system 200 may include a computing device, such as computing device 202. In its most basic configuration, the computing device 202 typically may include at least one processing unit 302 and memory 304. Depending on the exact configuration and type of computing device, the memory 304 may be volatile (such as RAM), non-volatile (such as ROM, flash memory, etc.) or some combination of the two. Additionally, the computing device 202 may also have additional features/functionality. For example, the computing device 202 may also include additional storage (removable and/or non-removable) including, but not limited to, magnetic or optical disks or tape. Some examples of such additional storage is illustrated in by removable storage 306 and non-removable storage 308. Computer storage media may include volatile and nonvolatile, removable and non-removable media implemented in any method or technology for storage of information such as computer readable instructions, data structures, program modules or other data. Memory 304, removable storage 306 and non-removable storage 308 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by the computing device 202. Any such computer storage media may be part of the computing device 202.

The computing device 202 may also have input device(s) 310 such as keyboard, mouse, pen, voice input device, touch input device, etc. Output device(s) 312 such as a display, speakers, printer, etc. may also be included.

The computing device 202 may also contain communications connection(s) 314 that allow the device to communicate with other devices. The communications connection(s) 314 is an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

A local provisioning module (LPM) 203 may provide part of the security basis surrounding a computing device 202 that may be configured for pay-per-use and pre-pay business models.

The LPM 203 may be a client side component of the service provider 216 provisioning system. The LPM 203 may reside in a computing system such as the computing device 202. The LPM 203 may perform various functions including interacting with users of the computing devices for interacting with the service provider 216 or resource providers 206 212 via the network 10, etc.

The LPM 203 may perform the function of enforcing a particular state on the computing device 202 by interacting with the particular login program used by the client computing device 202. In a particular implementation where the client device is using the Windows® product activation (WPA) system as the login logic, the LPM 203 may interact with the WPA to enforce the particular state on the client computing device 202. However, in an alternate implementation, the LPM 203 may interact with any other appropriate operating system login program. The implementation of the LPM 203 may be a grouping of various logical components implemented in software and composed as a library linked into a login program used by the WPA. However, in an alternate implementation of the LPM 203, one or more of the various logical components of the LPM 203 may be implemented in hardware.

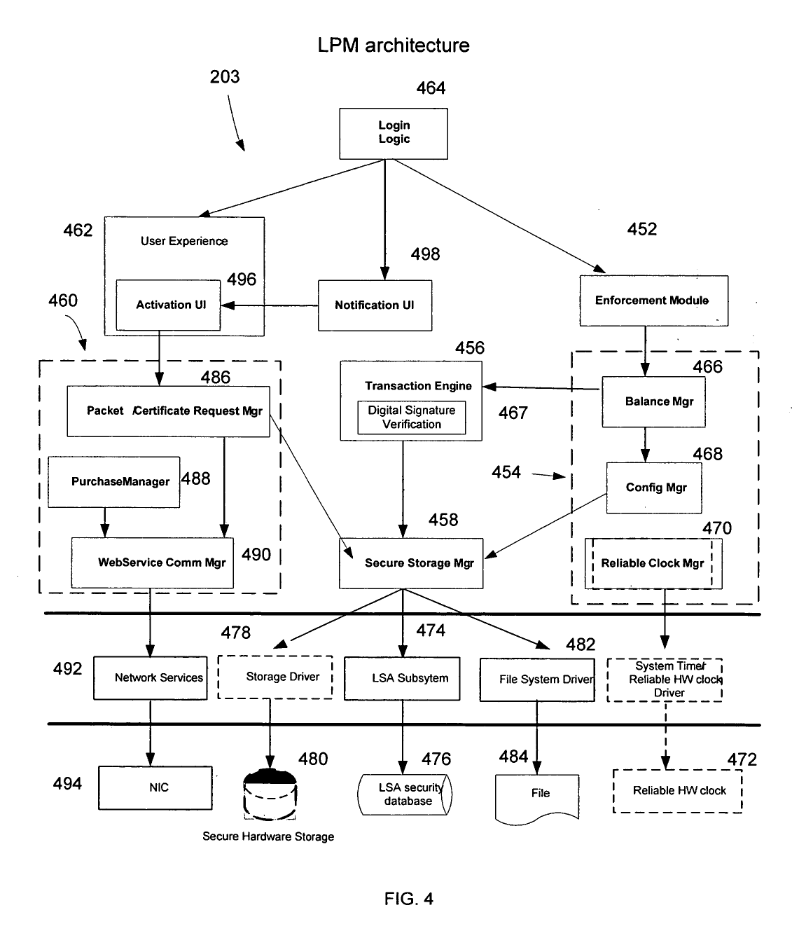

FIG. 4 illustrates a further detailed block diagram of the LPM 203. Specifically, the LPM 203 may include an enforcement add-on module 452 to enforce the computing device 202 to operate in a particular state, a metering module 454 to meter usage of a resource provisioned on the computing device 202, a transaction engine 456 to process provisioning packets provided by the service provider 216, a secure storage manager 458 to provide secure storage for the provisioning packets, a communication module 460 to communicate with the service provider 216, and a user experience module 462 to interact with a user.

The enforcement module 452 may be inserted into the login logic 464 of the computing device 202. When a user logs onto the computing device 202 using the login logic 464, or requests use of a chargeable provisioned resource 206 212 (FIG. 2), the enforcement module 452 may query the metering module 454 for balance information. If the enforcement module 452 determines that the computing device 202 has enough value for the requested activity, it may allow the computing device 202 to operate in its normal manner and allow the user to log onto the computing device 202, or use the requested resource 206 212. However, if the enforcement module 452 determines that the computing device 202 does not have enough value available, it may deny the login or access to the requested resource and may invoke a user interface to prompt the user to add value to the available balance.

To carry out the enforcement task, the enforcement module 452 may be able to disable or otherwise sanction resources under the direct influence or control of the computing device 202. Sanctions related to external peripherals may be enforced by action on an appropriate controller, for example, input or output controllers 310 312, but in some cases, the sanction may need to be carried out at the peripheral itself.

The metering module 454 may include a balance manager 466 for reading and verifying a current balance available for usage of provisioned resource and for updating the current balance. The metering module 454 may also include a configuration manager 468 for determining valid system configuration information, such as authorized, i.e. chargeable, peripherals and a reliable clock manager 470 for maintaining an always increasing timer. The metering module 454 may provide the mechanism for monitoring how often, how much, or over what period the computing device 202, or components thereof, are used. The metering module 454 may utilize hooks in the operating system to count application starts when usage is metered by application. Alternately, the metering module 454 may monitor the processing unit 302 cycles/usage to determine how much the computing device 202 or an individual application has actually been in operation. In another alternate embodiment, the reliable clock manager 470 may be monitored to determine when a given period for authorized use has expired, for example, a calendar month or 30 days.

The reliable clock manager 470 may use a reliable hardware clock 472 to accomplish the task of maintaining the monotonically changing timer. The reliable clock manager 470 may be used to provide system time, or may be used to provide time service only for usage metering. Both have advantages and may be used, but in either case, metering based on Greenwich Mean Time (GMT) may reduce nuisance problems with local time zones and the Date Line. The balance manager 466 and the reliable clock manager 470 may be very sensitive and important to the secure operation of the LPM 203, and therefore they are likely to be under various security attacks during the operation of the LPM 203.

The enforcement add-on module 452 and the metering module 454 may work together to implement activation and de-activation of the provisioned resource on the computing device 202. The enforcement add-on module 452 may function as an event dispatcher that invokes the balance manager 466 based upon certain events, while the balance manager 466 may determine what action to take when it is invoked in response to an event. Examples of various events that may cause the enforcement add-on module 452 to invoke the balance manager 466 are (1) a logon event, (2) a system unlock event, (3) a restore from hibernation event, (4) a wake up from standby event, (5) a user triggered event, such as a request to use a peripheral (6) a logoff event, (7) a packet download, (8) a timer tick, etc. The balance manager 466 may accept the event as an input and return a result action to the enforcement add-on module 452.

The transaction engine 456 may process a provisioning packet in order to update a balance in the balance manager 466. The transaction engine 456 may ensure that any provisioning packet is consumed only once to update the balance. The transaction engine 456 may be designed so that it performs atomic update and reconciliation transactions, thus either both of the balance and the resource provider accounts are updated or neither the balance and resource provider accounts are updated.

To process provisioning packets, the transaction engine 456 may include a digital signature verification circuit 467. The digital signature verification circuit 467 may have circuitry and/or software for decrypting the provisioning packet, whether the provisioning packet is received electronically over the Internet, locally from a local area network, from removable media, entered manually, or another method of transport. When using traditional public key infrastructure (“PKI”) the message may be decrypted, if encrypted, and the hash may be generated and checked against the digital signature to validate the integrity and authenticity of the provisioning packet. The particular encryption algorithm employed, for example, RSA™ or elliptic curve, is not significant. Digital signature technology including sender verification and content verification is well known and not covered in detail here.

The secured storage manager 458 may allow the LPM 203 to store balance data in a secured manner so that it cannot be tampered with by a user and so that it is accessible only by the LPM 203. After a provisioning packet is downloaded by the. LPM 203, it may be stored in the secured storage manager 458. Similarly, the balance counter and the packet consumption counter may also be stored in the secured storage manager 458. The secured storage manager 458 may also store data that is used in the set-up and operation of the local provisioning module 203. In general, this is data that, if compromised, may be used to circumvent the controls for pay-per-use or pre-pay operation. Among such data may be a unique identifier, that may be a number or code that can be used to identify one computing device 202 from another. The unique identifier may be used to prepare digitally signed provisioning packets that can only be used with a single machine. Provisioning packets may be data received that add value to the balance manager 466.

Some of the data associated with the authentication of provisioning packets may be stored in the secure storage manager 458. For example, a transaction sequence number may be used to discourage or prevent replay attacks. In addition, a “no-earlier-than” date may be extracted from the provisioning packet and stored to discourage or prevent clock tampering attacks. In one embodiment, the no-earlier-than date may be the date/time that the provisioning packet was created. Because the use of the provisioning packet may not take place before the provisioning packet was created, neither may the clock of the computing device 202 be set to a date or time prior to the latest date of the last provisioning packet, after accounting for time zones.

State data, stored by the secure memory manager 458, may be used to indicate whether the computing device 202 is in a fully operational mode or if the computing device 202 or an application is under some restriction. While most software may be stored or executed from general system memory 304 there may some, executable code, for example, applications, routines, or drivers that are ideally tamper resistant. For example, a routine that sets the reliable hardware clock 472 may itself need to be protected to prevent tampering and fraud.

Metering or usage data created or used by the metering module 454 may need more protection than that offered by system memory 304 and may therefore be stored in the secure storage manager 458. Metering or usage data may include, for example, the number of usage units remaining, the maximum number allowable usage units, a list of metered applications, or a stop time/date. Closely related to metering or usage data may be the usage plans. To provide flexibility, users may be allowed to select from a number of usage plans, as mentioned above. These usage plans may include use by period; use for a number of hours, use by application using either number of activations or usage, use by input/output (network connectivity), as well as others including combinations of the above. Protection of the usage plans may be important because it is not desirable for a user to be able to alter or create new plans that could result in fraudulent use.

A certificate revocation list (“CRL”) may be used to determine if the current root certificate is valid. When not retrieved real-time from a host, the CRL may be securely stored locally to prevent tampering that may allow fraudulent use by presenting a provisioning packet signed by a compromised or non-authorized private key. While the public keys of a root certificate are in the public domain and technically do not need protection, in the interest of the integrity of provisioning packet verification, the root certificate may be stored in the secure storage manager 458. In the illustrated implementation, the secured storage manager 458 is implemented as a dynamic link library (dll) so that the user experience module 462 can access the secured storage manager 458.

To ensure that the data stored in the secured storage manager 458 is secure, a data encryption key may be used to store the data in the secured storage manager 458 and only a module having a data encryption key is able to read the data from the secured storage manager 458. The secured storage manager 458 may communicate with a local security authority (LSA) subsystem 474 to communicate with an LSA database 476, a storage driver 478 to communicate with secure hardware storage 480, and a file system driver 482 to communicate with a file 484 on the computing device 202. For added security, an alternate implementation of the secured storage manager 458 may also use multiple copies of the data stored in the secured storage manager 458 so that each copy can be cross-referenced to ensure that there is no tampering with any single copy of the data. While the implementation of the LPM 203 discussed here has the secured storage manager 458 implemented in software, in an alternate implementation, the secured storage manager 458 may be implemented in hardware.

The communication module 460 may include a packet/certificate request manager 486 to request provisioning packets and/or certificates or to purchase additional provisioning packets from the service provider 216, and a web service communication manager 490 that allows the LPM 203 to communicate with the network 10.

The packet/certificate request manager 486 may receive a request to download a packet or a certificate from the service provider 216. For example, the packet/certificate request manager 486 may communicate with the service provider 216 to receive a certificate from a known source, such as the service provider 216. The packet/certificate request manager 486 may also be responsible to acknowledge to the service provider 216 upon successful download of a certificate or a provisioning packet. The packet/certificate request manager 486 may use a provisioning protocol to communicate with the service provider 216. A packet downloaded by the packet/certificate request manager 486 may be stored in the secured storage manager 458.

The purchase manager 488 may allow a user of the computing device 202 to add value to the local balance by purchasing provisioning packets by receiving payment information from the user and communicating the payment information to the service provider 216 or a funding account 220 (FIG. 2). For example, the purchase of a scratch card at a local outlet can be used to add value to the funding account 220 that is then used to create a provisioning packet that is downloaded, verified and used to update the balance. Both the packet/certificate request manager 486 and the purchase manager 488 may communicate with the network 10 using the web service communication manager 490. The web service communication manager may use a network services manager 492 and a network interface card (NIC) 494 to communicate with the network 10. Note that in one implementation, the web service communication manager 490 is used to communicate with the network 10, in another implementation, other communication tools, such as file transfer protocol (FTP), etc., may be used to communicate with the network 10.

The user experience module 462 may include an activation user interface (UI) 496 to ask a user to enter an InitKey that allows the packet/certificate request manager 486 to download the certificate from the service provider 216, and a notification UI 498 that allows the LPM 203 to interact with the user. The activation UI 496 may also invoke the purchase manager 488 to allow a user to purchase additional provisioning packets for balance recharging.

The notification UI 498 may include various user interfaces that allow the user to query current balance information, usage history, etc. The notification UI 498 may be invoked by the user or by the login logic 464. In a situation where the balance available for using a provisioned resource is low, the login logic 464 may invoke the notification UI 498 to inform the user that an additional purchase may be necessary. The notification UI may be constantly active and it may provide notification service to the user via a taskbar icon, a control panel applet, a balloon pop-up, or by using any other commonly known UI method.

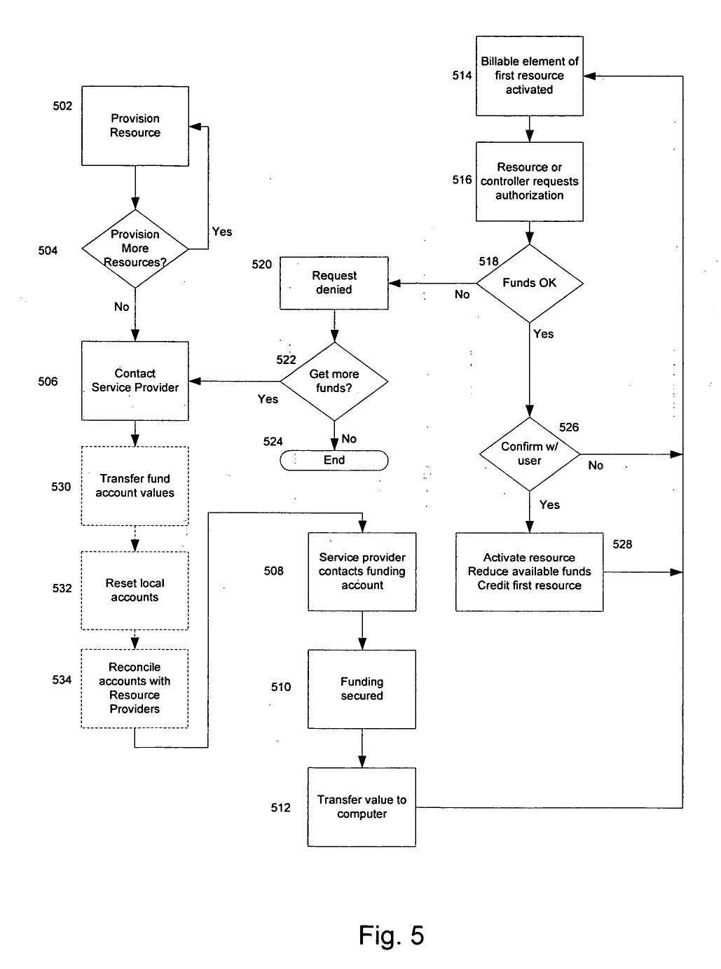

FIG. 5, depicting one exemplary operation of the system of FIG. 2 will be discussed and described. A first resource provider 204 may provision 502 a first resource 206 on the computer 202. If more provisioning is to be done, the yes branch of 504 may be taken to repeat the provisioning 502 for a second resource provider 210. Provisioning of resources 206 210 may not necessarily be limited to a particular time and may be performed at any point in the lifecycle of the computer 202. As discussed above, the provisioning can be physical or logical and may not necessarily require the resource provider 204, 210 to be aware the provisioning occurred. When initial provisioning is complete the no branch of 504 is taken.

The computer 202, either by a user action or by an automated process, may contact 506 the service provider 216 to add value to the LPM 203. The service provider 216 may contact 508 a funding account 220 to request funds. The funding account 220 may confirm the request and confirm 510 funds availability to the service provider 216. When funds are actually transferred to the service provider 216 at this time or only confirmed and reserved may be business model or implementation specific. The service provider 216 may respond 512 to the computer 202 by creating and sending a provisioning packet to add value 512 to the LPM 203. As discussed above, the units of the value stored may be any arbitrary representation of value, for example, currency, points, minutes, megabytes of data, etc. Should the funding be denied at step 510, the service provider 216 may reply to the computer 202 with an appropriate message, for example, noting the denied fund request or requesting information regarding another funding account (not depicted).

When the computer 202 initiates 514 an activity involving a billable aspect of the first resource 206, the first resource 206 or an associated controller (not depicted) requests 516 authorization to perform the requested function. The request may involve a simple request associated with starting up the resource or may be a more complex request involving a specific use, such as printing 5 pages, or continued operation of a resource already in use, for example, a computer game. Additionally, the requested resource may be more granular, for example, the use of a feature of a program such as spell checking in a word processing program. The resource may be a utility, for example, dictionary or search tool. Further, the resource maybe function supported by the computer 202, such as a display graphics mode or a web camera. More complex usage plans may be developed using combinations of resources. For example, a usage plan may include unlimited use of the computer 202 for a month plus a number of points for that month for media content, i.e. music. Another usage plan may include unlimited use of the computer 202 for a month and limited use of a photo editor for the month.

Alternatively, the requested function may be associated with a service performed on the computer 202 by the service provider 216, one of the resource providers 204 210, or a third party (not depicted). The service may be a maintenance function, an upgrade, user support related to installation, repair or diagnostics, etc. In yet another alternative, the resource may be a local resource provisioned on the computer 202 but not enabled, whereby the value stored on the computer may be used to unlock the local resource, for example, a game or photo editor, for either limited or unlimited use. Along this line, the resource may be capable of increased or decreased functionality, such as the display graphics mode. In this case, the value can be used to enable either limited or unlimited use of a high resolution graphics mode, or refund value for use of a lower graphics mode when high resolution is not required.

The enforcement module 452 in conjunction with the metering circuit 454 may determine 518 whether there is sufficient value or points to meet the terms of the requested service. When there is not, the no branch of 518 may be followed. A message may be presented 520 to the user or an automated recharge process. If the user requests or a programmatic decision is made to get more funds, the yes branch from 522 may be followed to step 506 where execution proceeds as described above.

When there are sufficient funds, the yes branch of 518 may be followed. The user may be asked to confirm 526 the allocation of funds to the specified resource 206 or activity. At this point the user may also be asked to select from various payment plans, depending on implementation. If the user refuses, the no branch from 526 may be followed and the process may wait for a new resource selection at 514. In some cases, a rule base may allow for automatic confirmation, such as, confirming with the user only when the transaction is greater than a certain amount, or only after a total of automatically confirmed transactions exceeds a predetermined amount.

If the user approves the fund allocation to the resource 206, the yes branch of 526 may be followed. At 528 the enforcement module 452 may authorize the resource 206, the metering circuit 454 may subtract value from the available funds in the balance manager 466 and allocate that amount of funds to the selected resource 206.

At any point when the computer 202 is in communication with the service provider 216, as at step 506, additional steps to reconcile the balances may occur. Values allocated to specific resources, in the last example, resource 206, including the current available balance may be transferred 530 to the service provider 216. When the transfer is confirmed, the balances in the computer 202 may be reset 532, indicating that the local value accounts have been successfully reconciled 534 and the individual resource providers 204 210 have been credited for the use of their respective resources on the computer 202. When desired by the user, the available balance on the computer or a portion thereof, may be transferred back to the funding account 220. When implemented in this fashion, the pay-per-use model described may be easily contrasted with other pay-per-use or pre-paid “use it or lose it” business models.

While in contact 506 with the service provider 216, additional offers, specials, or other service plans may be made available to the user. When accepting a new usage plan, for example, the service provider 216 may securely transmit the new usage plan in a manner similar to that used for transferring value to the computer 202.

The trigger for entering step 506, that is, contacting the service provider 216 may also include automated events, depending on the service contract and the communication capabilities of the computer 202. For example, the computer 202 may contact 506 the service provider in response to a specific date, such as the 20^{th} of each month. In another example, the computer 202 may contact 506 the service provider 216 in response to the value reaching a pre-determined low-water mark, triggering an automatic re-provisioning of a given amount of value. Such automatic triggers are known and may be a convenience to users who are then relived of the routine task of re-provisioning the computer 202.

The service provider 216 may, at times, need or want to reduce the value in the balance manager 466 using a roll-back message. There are several reasons this may occur, such as non-sufficient funds in the funding account 220, an accounting error, or suspected fraud. In such cases, the service provider 216 may proactively contact the computer 202, or wait for a normal user or computer-generated access. When in communication with the computer 202, a negative provisioning packet may be sent to the LPM 203 and processed normally. This transaction may require the same level of protection and cryptographic security, because even though fraud is not an issue, such capability could be the source of a denial-of-service attack.

Obviously, many variations of this specific example can be comprehended. For example, the resource providers 204, 210 may be the same as the service provider 216. There may be more than one service provider 216, as discussed above. The provisioning process 502 may take place through the service provider 216 or others. The funding account 220 may be associated with the resource providers 204, 210, that is, payment is made directly to the providers without a clearinghouse function at the service provider 216. The value stored in the computer 202 may be used for electronic commerce transactions, when suitable trust relationships are in place. In poor countries, the transactions could be carried out by an auction/barter system rather than in currency. The use of the LPM 203 does not have to be restricted to computer-related assets, but could be used for other transactions, such as on-line purchases.

Additionally, an obvious fraud hazard may arise if any service provider other than the service provider 216 associated with the computer 202 or a particular resource 206 212 were able to add value to the LPM 203 for provisioning that resource, steps must be taken to mitigate that possibility. To prevent hacking and a, black market in provisioning of resources, strong measures may be taken. These are discussed in more detail in related applications filed under application (TBD), attorney docket number 30835/40477, titled, “Isolated Computing Environement Anchored Into CPU and Motherboard.”

We claim:

1. A method for charging for use of a resource, the resource associated With a resource provider, the resource coupled to a computer, wherein the computer comprises a processor, a memory, and a usage metering circuit, the method comprising:
transferring value to an account on the computer;
maintaining the value in the account on the computer;
modifying the value in the account corresponding to use of the resource; and
allocating value to the resource provider corresponding to use of the resource.

2. The method of claim 1, further comprising:
presenting a charging option when activating the resource.

3. The method of claim 1, further comprising:
authorizing modifying the value in the account before using the resource.

4. The method of claim 1, further comprising:
coupling to a billing function; and
reconciling the value associated with using the resource.

5. The method of claim 1, wherein the resource is one of a software program, a hardware resource, a media content, a peripheral, and an operating system.

6. The method of claim 1, wherein the resource is a service.

7. The method of claim 1, wherein the resource is one of a feature of a software program, a utility, and a function supported by the computer.

8. The method of claim 1, wherein the resource is a local content and use of the resource comprises unlocking the resource.

9. The method of claim 1, further comprising:
modifying the value in the account corresponding to an electronic commerce transaction; and
allocating value to the electronic commerce provider corresponding to the electronic commerce transaction.

10. The method of claim 1, further comprising:
modifying the account according to a payment schedule, the payment schedule associated with use of the resource.

11. The method of claim 10 wherein the resource has one of increased and decreased functionality, the one of increased and decreased functionality determined by the payment schedule.

12. The method of claim 1, further comprising:
limiting access to the resource when the account reaches a limit.

13. The method of claim 1, wherein transferring value to the account on the computer comprises transferring value from a funding account to the account on the computer.

14. The method of claim 13 wherein the funding account is one of a bank account, a prepaid account, and a stored value account.

15. The method of claim 13, further comprising operatively coupling the computer to the funding account when the account reaches a limit.

16. The method of claim 1, further comprising:
associating the resource with a resource provider; and
compensating the resource provider for the use of the resource.

17. The method of claim 16, further comprising:
maintaining a history of the account;
transferring value to the resource provider according to the history.

18. The method of claim 1, wherein use of the resource comprises use of the resource for one of an activation, an activation of a feature of the resource, and over a period of time.

19. A method for payment for use of an end-user computer resource, the end-user computer resource associated with a resource provider, the method comprising:
assigning a consumed value to the resource provider, the consumed value corresponding to use of the end-user computer resource; and
compensating the resource provider corresponding to the consumed value.

20. The method of claim 20, further comprising adding value to a funding account; and
transferring value to a local account, the local account residing on an end-user computer;

21. The method of claim 20, wherein transferring value to the local account further comprises transferring value to the local account in response to a trigger event.

22. The method of claim 20, wherein the trigger event is one of a date and the local account reaching a predetermined level.

23. The method of claim 20, further comprising:
moving value from the local account to the consumed value at a rate defined by a payment schedule.

24. The method of claim 20, further comprising:
resetting the consumed value in association with compensating the resource provider.

25. The method of claim 20, further comprising resetting the value in the local account according to a roll-back message.

26. A computer configured for metering use of a resource thereon comprising:
a non-volatile memory providing restricted access to data stored therein;
a value account stored in the non-volatile memory;
a usage metering circuit coupled to the value account; and
a resource responsive to usage metering circuit, wherein the usage metering circuit permits operation of the resource while the value account meets a requirement.

27. The computer of claim 26, wherein the non-volatile memory further comprises a payment schedule.

28. The computer of claim 26, wherein the resource is one of a software program, a feature of the software program, a hardware component, a peripheral interface, a media content, and a communication component.

29. The computer of claim 26, wherein the value account is one of a post-paid account and a pre-paid account.

30. The computer of claim 26, wherein the value account maintains an accounting of the operation of the resource.

31. The computer of claim 26, wherein the value account is reduced in response to a roll-back signal.
